(19) United States
(12) Patent Application Publication
(10) Pub. No.: US 2007/0259687 A1
(43) Pub. Date: Nov. 8, 2007

(54) Method and Apparatus for Routing Content for a Mobile Phone Over an Alternative Wireless Network

(75) Inventors: William X. Huang, San Ramon, CA (US); Suyu Bao, Fremont, CA (US); Liming Gao, Alameda, CA (US); Shanquan Bao, Alameda, CA (US); Guang Wan, Fremont, CA (US)

Correspondence Address: FELIX L. FISCHER, ATTORNEY AT LAW, 1607 MISSION DRIVE, SUITE 204, SOLVANG, CA, 93463, US

(73) Assignee: UTStarcom, Inc., Alameda, CA (US)

(21) Appl. No.: 11/381,594

(22) Filed: May 4, 2006

(51) Int. Cl. H04M 1/00

(52) U.S. Cl. 455/552.1; 455/41.2; 709/223

(57) ABSTRACT

A device for network routing control of voice/data traffic for a mobile phone having a primary communication network incorporates a short range radio interface communicating with a compatible radio interface in the mobile phone and a wireless communications interface communicating voice/data traffic received through the short range radio interface to an alternative wireless network and traffic received from the alternative wireless network to the short range radio interface. The device is packaged with a media player receiving content over the alternative wireless network and storage for the media content and mobile phone data.

### BACKGROUND OF THE INVENTION

1. Field of the Invention

This invention relates generally to the field of routing of mobile phone voice/data traffic and more particularly to a device incorporating a short range radio interface for communicating with a mobile phone having a compatible interface and communicating with a primary wireless network, the device further having a wireless communications interface to an alternative wireless network wherein voice/data traffic for the mobile phone can be routed over the alternative wireless network through the short range radio interface and wireless communications interface in the device.

2. Description of the Related Art

Most mobile phones operate through a standard wireless network protocol such as GSM or CDMA through a Public Land Mobile Network (PLMN). Alternative wireless networks such as Personal Handyphone Systems (PHS), WiFi, WiMax, WCDMA, cdma2000 or similar systems are very rapidly expanding in service area and capabilities. Mobile phone users are often located where the alternative wireless network may offer less expensive or better quality service for voice/data traffic. However, the calls made by users are often via their mobile phone's primary wireless network instead of the alternative wireless networks with less expensive or better QoS because of the convenience and user affinity with their mobile handset; the mobile phone is always with the user, it contains all of users contact details, and user is extremely familiar with the mobile phone's functionality etc. Many mobile phones are now dual mode incorporating a short range radio interface such as Bluetooth® for connectivity with other user devices such as personal computers and Personal Digital Assistants (PDAs). Additionally, many of the alternative wireless systems provide media capabilities for users with media players such as MP3 devices and many users carry both a mobile phone and the media player for personal use.

It is therefore desirable to provide a device for automatically routing calls from a mobile phone to an alternative wireless network when the user is within range of the alternative network allowing users to enjoy the less expensive and better QoS provided by the alternative wireless network without changing their usage habits. It is also desirable that the device provide media storage, Wireless Access Protocol (WAP)/Web server, and media player service in association with the alternative wireless network for commonality of service use.

### SUMMARY OF THE INVENTION

The present invention provides a method and device for routing voice/data traffic of a mobile phone over an alternative wireless network (such as PHS, or WiMax, or WCDMA, or cdma2000) via a suitable interface such as Bluetooth®. The device in certain embodiments also provides content storage, WAP/Web server, and media player functions. In an exemplary embodiment, the device incorporates a Bluetooth interface, one alternative wireless communication interface, content storage modules, WAP/Web server, and a media player (such as MP3) integrated in a single portable case. The device provides customers a cost-effective communication and entertainment solution.

The operation of a device incorporating the present invention is associated with a compatible mobile phone such as a dual /multi-mode Bluetooth mobile phone. When the user is within the radio range of the alternative wireless network that supports the wireless technology embedded in the device, the voice/data traffic of the mobile phone can be transparently routed via the device to the alternative wireless network instead of the mobile phone's primary wireless network, This routing process fulfilled in exemplary embodiments by the protocol conversion between Bluetooth protocols (such as Bluetooth CTP protocol etc) and the alternative wireless network's protocols. The additional functionality of the device provides content storage for the mobile phone, the capability to download multimedia content via the alternative wireless network, and/or the ability to act as a media player (such as an MP3 player), and/or WAP/Web server.

### BRIEF DESCRIPTION OF THE DRAWINGS

These and other features and advantages of the present invention will be better understood by reference to the following detailed description when considered in connection with the accompanying drawings wherein:

FIG. 1 is a block diagram of the elements in a first embodiment of a device incorporating the present invention;

FIG. 2 is a schematic diagram showing the content flow paths associated with the invention;

FIG. 3 is a functional work diagram showing the operation of the embodiment of the invention for connection to the alternate wireless network;

FIG. 4 is a functional work diagram showing the operation of the elements of the embodiment of the invention for establishing an outgoing call on the alternative wireless network;

FIG. 5 is a functional work diagram showing the operation of the elements of the embodiment of the invention for an incoming call through the alternative wireless network; and,

FIG. 6 is a functional work diagram showing the operations in receiving content by the embodiment of the invention.

### DETAILED DESCRIPTION OF THE INVENTION

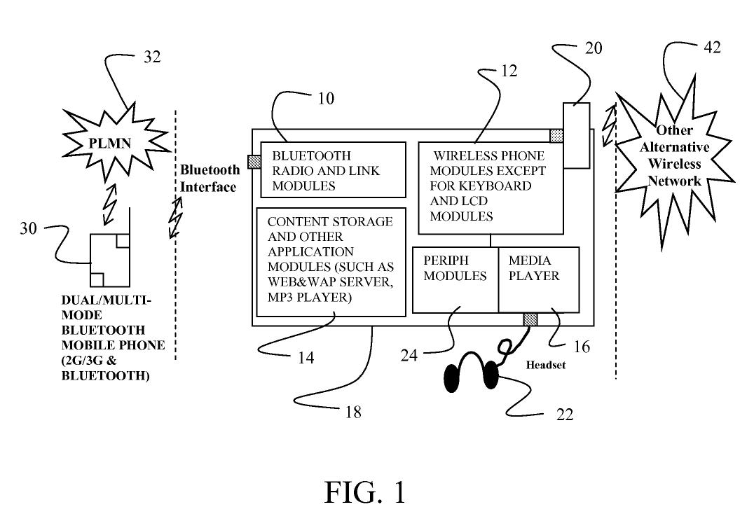

FIG. 1 shows an exemplary embodiment of a device incorporating the invention (hereinafter “the device”). The device incorporates a Bluetooth interface 10, an alternative wireless communication interface 12 employing PHS, WiFi, WiMax, WCDMA or other technology for an alternative wireless network, content storage modules 14, WAP/Web server 15 and a media player 16 (such as an MP3) integrated into a case 18. As shown in the drawings, the device incorporates an integral antenna 20 and headset connection 22 for the media player. A device 28 incorporating the invention as described herein has been designated by the assignee of the present application as a MiniQ™ accessory. The Bluetooth radio and link modules provide a Bluetooth interface which works as a transparent short-range bearer for routing voice/data traffic between the device and its associated Bluetooth enabled mobile phone 30. The embedded wireless communications interface (which for the embodiment shown do not include keyboard and LCD modules) in the device selectively establishes connections to the alternative wireless network. As will be described in greater detail subsequently, this routing process in exemplary embodiments is also fulfilled by a protocol conversion between Bluetooth (such as Bluetooth CTP protocol etc) and the alternative wireless network's protocol. The device content storage modules (such as flash/cashing memory) store data for the device and, in certain embodiments, the associated mobile phone. In certain embodiments, additional peripheral modules are also included in the device, such as an external memory card slot 24, etc.

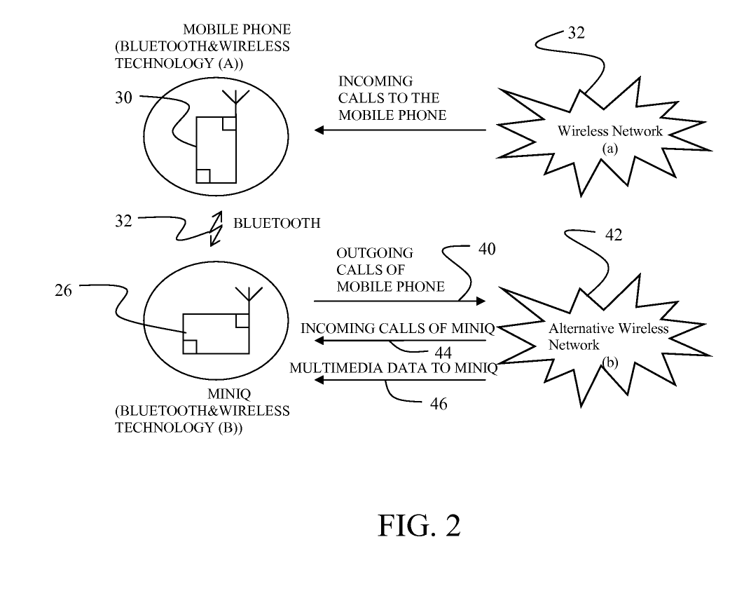

The device works in association with the Bluetooth enabled mobile phone as shown in FIG. 2. For outgoing calls 40 originated by the mobile phone 30, the voice/data traffic of the mobile phone is routed over Bluetooth air interface 32 to the device 26. The device accordingly establishes a connection to the called party via the alternative wireless network 42 which is supported by the wireless interface modules embedded in the device, and routes the mobile phone's voice/data traffic over the established connection. Similarly, an incoming call 44 from the alternative wireless network to the device is routed over the Bluetooth air interface to the mobile phone. Multimedia data content 46 is received by the device via the alternative wireless network for storage in the device.

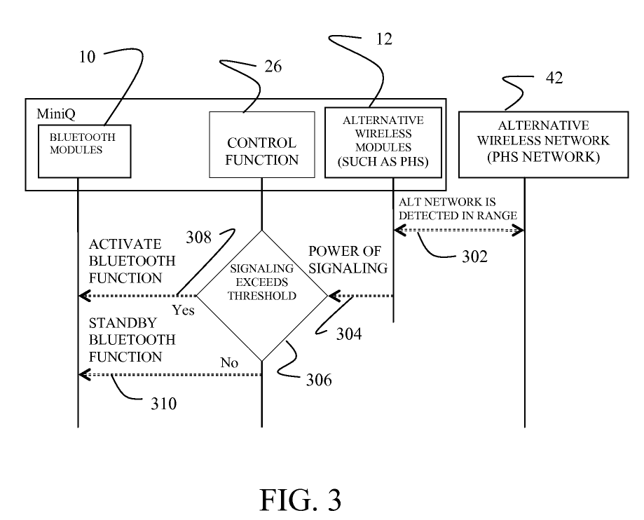

When the user is within the radio range of wireless network that supports the alternative wireless technology (such as PHS, WiFi, WiMax, WCDMA, cdma2000) embedded in device, the outgoing calls initiated from the mobile phone can be routed over Bluetooth interface to the device, this process is controlled manually or automatically in alternative embodiments. FIG. 3 is an example of automatic control incorporated in the device. The wireless communications module 12 in the device monitors the signal available 302 from the alternative wireless network 42 (for the example shown a PHS Network). If the signal power 304 of the detected alternative wireless network exceeds the threshold 306, as determined by controller 26, the Bluetooth functions (such as Bluetooth CTP profile) embedded in device are automatically activated 308 with resulting communication between the device and the mobile phone. Similarly, if the Bluetooth interface is currently active and the wireless communications module in the device senses that power has been reduced below the threshold, the Bluetooth interface will be set as standby 310 by the controller. Outgoing calls from the mobile phone would then be processed normally over the primary network for the mobile phone. In both instances, incoming calls over the primary network for the mobile phone would be received normally.

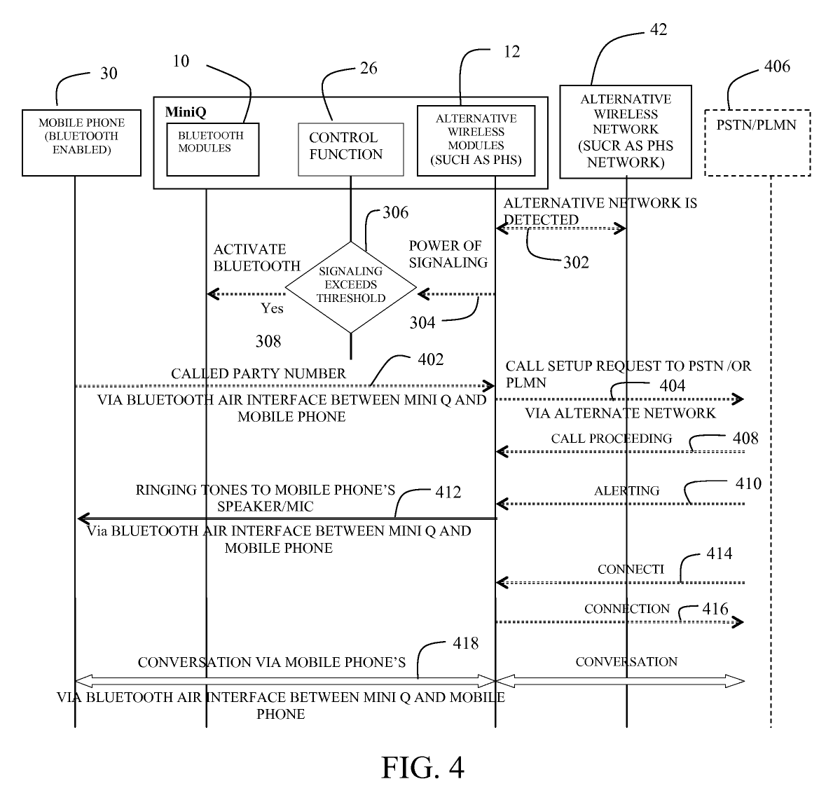

When an outgoing call is made by the associated mobile phone, the traffic of this outgoing call will be routed to device over the Bluetooth interface. The device handles all control protocol and content traffic to the external wireless network. The device will initiate an outgoing call to the called party through the alternative wireless network. As shown in FIG. 4, if the signaling power of the detected PHS network 42 (the alternative wireless network) exceeds the threshold 306 and the Bluetooth interface is activated 308, and the outgoing calls of the associated mobile phone are routed to the device via the Bluetooth interface. The called party number dialed on mobile phone is transparently forwarded 402 to the PHS modules 12 embedded in device via the Bluetooth interface. A PHS outgoing call SETUP 404 to the called party will be triggered through the PHS Network 42 to the Public Switched Telephone Network (PSTN) or Public Land Mobile Network (PLMN) 406 as appropriate. This routing process is also fulfilled in exemplary embodiments by the protocol conversion between Bluetooth protocols and PHS protocols (such as use Bluetooth CTP) profile in the device and the associated mobile phone, in this case, the associated mobile phone acts as a cordless phone of the device, and the voice/data traffic of the mobile phone can be routed to the PHS communication network via the device, the device handles the protocol conversion between Bluetooth CTP protocols and the PHS network's protocol (e.g., RCR STD-28)). The appropriate Call Proceeding 408 and Alerting 410 protocols are handled by the PHS Module in the device through the PHS Network. The device transfers the ringing tones 412 through the Bluetooth interface to the mobile phone speaker/mic. Call Connection 414 and Connection Acknowledgement 416 are transacted by the PHS Modules in the device. After the call is established between the called party and the device, the content comprising the conversation of the call will be transparently transmitted 418 between PHS modules and the speaker/mic of the mobile phone via Bluetooth interface and between the device and the other party on the PSTN/PLMN through the PHS Modules via the PHS Network.

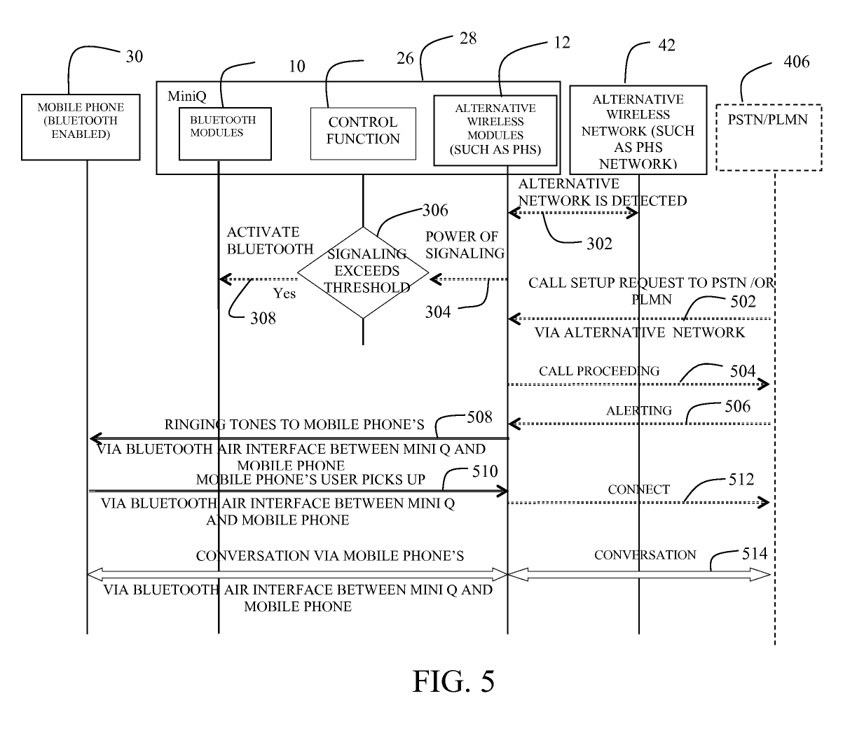

Similarly, when the device is within the radio range of wireless network that supports the alternative wireless technology (such as PHS in the example shown) employed by the device, the incoming calls to the wireless modules embedded in the device are routed to the mobile phone via Bluetooth interface. This routing process is alternatively fulfilled by the protocol conversion between Bluetooth protocols and the alternative wireless network's protocols. FIG. 5 is a call flow example of a Bluetooth/PHS dual-mode device's incoming call. A call SETUP request is received 502 from the PSTN or PLMN via the PHS network 42 by the PHS modules 12 in the device. Call proceeding 504 and Alerting 506 protocols are exchanged by the PHS module in the device and the PSTN/PLMN and Ringing tones are forwarded 508 to the mobile phone speaker via the Bluetooth air interface modules 10. The PHS wireless communications module embedded in device shares the keyboard and speaker/mic of the associated mobile phone via Bluetooth interface, the related data will be transparently transmitted via Bluetooth interface. The mobile phone user picks up the call 510 using the keyboard and speaker/mic on the associated mobile phone via the Bluetooth interface, and establishes the connection between the device and the PSTN/PLMN via the PHS network. This routing process is fulfilled in the exemplary embodiment by the protocol conversion between Bluetooth protocols and the alternative wireless network's protocols (such as use Bluetooth CTP profile in the device and the associated mobile phone, in this case, the associated mobile phone acts as a cordless phone of the device, and the voice/data traffic of the mobile phone can be routed to the alternative wireless network via the device, the device handles the protocol conversion 512 between Bluetooth CTP protocols and the PHS network's protocols (such as RCR STD-28)). The conversation 514 then progresses normally with content transfer between the mobile phone and the device through the Bluetooth interface and to the PHS network via the PHS modules.

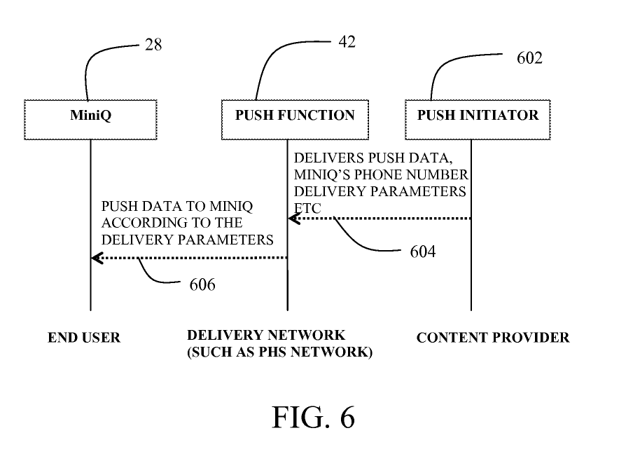

When the user is within the radio range of the wireless network that supports the alternative wireless technology embedded in device, multimedia content (such as MP3 songs) can be pushed or pulled to the device via the wireless modules embedded in the device over the alternative wireless network. The content storage module in the device then stores the contents. An example of this process is the “PUSH” service. In use, PUSH services ‘push’ the multimedia content to the device, there is no explicit request from the user before the content provider initiates an information transfer to a user (such as using SyncML protocol etc). As shown in FIG. 6, push service is the delivery of content to the mobile device without previous user interaction. The device explicitly or implicitly subscribes to a set of value added services offered by various Push Initiators 602 and allow these Push Initiators to send push data 604 that meet the Push Recipient's configured criteria through the delivery network 42, in the case shown, the PHS network. The phone number for the device and delivery parameters are included in the data provided by the PUSH Initiator to the delivery network which acts as the PUSH function. The device then receives content meeting predetermined delivery parameters as PUSH data 606. The device does not need to involve the user in the procedure of data download. The download procedure can be transparent to the user.

When the user is not within range of the wireless network coverage that supports the alternative wireless technology embedded in the device, the outgoing calls of the mobile phone are carried over the mobile phone's primary wireless network. In this case, the device acts as a normal MP3 player, a WAP/web server, and/or an external storage for the mobile phone with data transfer between the mobile phone and the device over the Bluetooth interface. When the device is out of range of the alternative wireless network, the standby Bluetooth function is activated by the associated mobile phone or by “force” (such as manually activating the function by a button on the device) in certain embodiments. In certain embodiments, all the outgoing calls of the associated mobile phone are routed to the device first, if the device is not within range of the alternative wireless network, a “no signal available” response is provided by the device and the call is routed via the mobile phone's primary wireless network, in this case, the Bluetooth remains active, and does not need to standby.

In certain embodiments, the device employs the speaker/earphone capability of the mobile phone as the sound medium for the user to play MP3 content from the device, again using the Bluetooth interface for communication between the mobile phone and the device. This eliminates the requirement for a separate speaker or earphone attachment and associated amplifiers in the device. Additionally, the device can be configured to create a notification message on receipt of new media via the Bluetooth interface to the mobile phone to notify the user that the new media has been received. Operation of the device in concert with the mobile phone further allows use of the mobile phone LCD and keyboard as data/input interfaces for the user to the media player elements of the device. With the WAP/Web server in the device the associated mobile phone is installed as a WAP client/Web browser and the users can access the content stored in the device initiated by using the mobile phone.

For the incoming calls of the mobile phone through the primary network 32, regardless of whether the user is within the radio range of the alternative wireless network supporting device's wireless technology, the incoming calls will be carried over the mobile phone's primary wireless network.

Having now described the invention in detail as required by the patent statutes, those skilled in the art will recognize modifications and substitutions to the specific embodiments disclosed herein. Such modifications are within the scope and intent of the present invention as defined in the following claims.

What is claimed is:

1. A device for network routing control of voice/data traffic for a mobile phone having a primary communication network, the device comprising:
a short range radio interface communicating with a compatible radio interface in the mobile phone; and
a wireless communications interface communicating voice/data traffic received through the short range radio interface to an alternative wireless network and traffic received from the alternative wireless network to the short range radio interface.

2. A device as defined in claim 1 wherein the wireless communications interface senses being within range of the alternative wireless network and control of the outgoing calls of the associated mobile phone are routed to the alternative wireless network via the short range radio interface.

3. A device as defined in claim 1 wherein the short range radio interface is a Bluetooth interface.

4. A device as defined in claim 1 further comprising storage means for content received through the short range radio interface and the wireless communications interface.

5. A device as defined in claim 1 further comprising a media player operably connected to the storage means.

6. A device as defined in claim 1 further comprising a WAP/Web server.

7. A system for network routing control of voice/data traffic comprising:
a mobile phone having a primary communication network and a short range radio interface;
a routing device having
a short range radio interface communicating with the short range radio interface to the mobile phone; and
a wireless communications interface communicating voice/data content received through the short range radio interface to an alternative wireless network and content received from the alternative wireless network to the short range radio interface.

8. A system as defined in claim 7 wherein the wireless communications interface senses being within range of the alternative wireless network and control of the outgoing calls of the associated mobile phone are routed to the alternative wireless network via the short range radio interface.

9. A system as defined in claim 7 wherein the short range radio interface is a Bluetooth interface.

10. A system as defined in claim 7 wherein the routing device further comprises storage means for content received through the short range radio interface and the wireless communications interface.

11. A system as defined in claim 7 wherein the routing device further comprises a media player and WAP/web server operably connected to the storage means.

12. A method for routing control of voice/data traffic for a mobile phone having a primary communication network comprising the steps of:
communicating between a routing device and the mobile phone using a short range radio interface;
communicating voice/data traffic received through the short range radio interface to an alternative wireless network and traffic received from the alternative wireless network to the short range radio interface through a wireless communications interface in the routing device.

13. A method as defined in claim 12 further comprising the steps of:
determining if the alternative wireless network is in range and, if so,
controlling the outgoing calls of the associated mobile phone to be routed to the alternative wireless network.

14. A method as defined in claim 12 wherein the step of communicating using a short range radio interface initially comprises the step of:
forwarding a called party number dialed on mobile phone to the wireless communications interface;
and wherein the step of communicating voice/data traffic comprises the steps of:
triggering an outgoing call SETUP to the called party through the alternative wireless network to the Public Switched Telephone Network (PSTN) or Public Local Mobile Network (PLMN);
transferring Call Proceeding and Alerting protocols between the wireless communications interface in the device through the alternative wireless network;
the step of communicating using a short range radio interface further including transferring ringing tones through the short range radio interface to the mobile phone speaker/mic;
and the step of communicating voice data traffic then including transacting Call Connection and Connection Acknowledgement through the wireless communications interface;
after the call is established between the called party and the wireless communications interface, the step of communicating using a short range radio interface further comprises the step of transmitting the content comprising the conversation of the call between wireless communications interface and the speaker/mic of the mobile phone via the short range radio interface and the step of communicating voice/data traffic includes transmitting between the device and the other party on the PSTN/PLMN through the wireless communications interface via the alternative wireless network.

15. A method as defined in claim 14 wherein the short range radio interface is a Bluetooth interface and routing between the Bluetooth interface and the alternative wireless interface is fulfilled by the protocol stack conversion between Bluetooth protocol and alternative wireless network protocol.

16. A method as defined in claim 12 wherein the step of communicating voice/data traffic initially comprises the steps of:
receiving a call SETUP request from the PSTN or PLMN via the alternative wireless network by the alternative wireless communications interface;
exchanging call proceeding and Alerting protocols between the alternative wireless communications interface and the PSTN/PLMN;
and the step of communicating using a short range radio interface initially comprises the steps of forwarding ringing tones to the mobile phone speaker via the short range radio interface; and
picking up the call using the mobile phone keypad which is routed via protocol stack conversion to the alternative wireless communications interface;
the method further comprising the steps of connecting to the PSTN/PLMN via the alternative wireless network; and
transmitting content comprising the conversation of the call between wireless communications interface and the speaker/mic of the mobile phone via the short range radio interface and between the device and the other party on the PSTN/PLMN through the wireless communications interface via the alternative wireless network.

17. A method as defined in claim 16 wherein the short range radio interface is a Bluetooth interface and routing between the Bluetooth interface and the alternative wireless interface is conducted transparently via the Bluetooth interface

18. A method as defined in claim 16 wherein the short range radio interface is a Bluetooth interface and routing between the Bluetooth interface and the alternative wireless interface is fulfilled by protocol conversion between Bluetooth protocol and alternative wireless network protocol.

19. A method as defined in claim 16 wherein the short range radio interface is a Bluetooth interface and routing between the Bluetooth interface and the alternative wireless interface is fulfilled using Bluetooth CTP profile protocol conversion.

20. A method as defined in claim 12 further comprising the steps of:
subscribing to a set of value added services offered by various Push Initiators;
receiving through the wireless communications interface push data that meet configured criteria from the alternative wireless network; and
storing the push data as media content.
